(19) United States
(12) Patent Application Publication
(10) Pub. No.: US 2013/0139002 A1
(43) Pub. Date: May 30, 2013

(54) DEBUGGING METHOD AND COMPUTER SYSTEM USING THE SAME

(71) Applicant: Wen-Cheng Huang, New Taipei City (TW)

(72) Inventor: Wen-Cheng Huang, New Taipei City (TW)

(21) Appl. No.: 13/363,393

(22) Filed: Feb. 1, 2012

(30) Foreign Application Priority Data
Nov. 24, 2011 (TW) 100143092

(51) Int. Cl. G06F 11/28

(52) U.S. Cl. 714/30; 714/E11.178

(57) ABSTRACT

A debugging method for a plurality of processor cores is disclosed, which includes defining a debug data transmitting zone in a storage device, utilizing a first processor core for generating a debug data and transmitting the debug data to a second processor core via the debug data transmitting zone for debugging.

### BACKGROUND OF THE INVENTION

1. Field of the Invention

The present invention relates to a debug method and computer system thereof, and more particularly, to a debug method capable of accessing entire execution data for debugging without additional hardware circuit and computer system thereof.

2. Description of the Prior Art

When designing a multi-core program in a multi-core processor, a program designer needs to utilize various debug methods for debugging the multi-core program. Generally speaking, when the multi-core processor executes the multi-core program, each processor core of the multi-core processor executes different parts of the multi-core program and achieves the multi-core program results through transmitting data between each processor core. However, in the multi-core processor, not all the processor cores have channels for outputting execution data. As a result, when the program designer wants to debug the multi-core program, the program designer cannot access execution data of all the processor cores. Therefore, the difficulty of debugging the multi-core program increases since the program designer cannot access the execution data of all the processor cores.

For the processor cores that cannot output execution data itself, the conventional method is utilizing an In-Circuit Emulator (ICE) accompanied by debugging interfaces defined in advance, such as Joint Test Action Group (JTAG) and enhanced Joint Test Action Group, for implementing a contact with a processor core of the multi-core processor. Via the In-circuit Emulator, the program designer can access the processor core of the multi-core processor while the processor core is executing programs, so as to allow the program designer to access the execution data for debugging.

However, the implementation of the In-Circuit Emulator for debugging needs additional hardware circuitry. Moreover, each processor core requires a corresponding In-circuit Emulator and a corresponding debugging interface. In such a situation, the additional hardware circuitry increases with the number of the processor cores, and so too the developing cost of the multi-core program. For the program designer, the complexity of designing the multi-core program also increases. Therefore, how to effectively achieve program debugging without additional hardware circuitry is a problem desired to be solved.

### SUMMARY OF THE INVENTION

Therefore, the present invention provides a debug method and computer system thereof capable of accessing entire execution data without additional hardware circuitry.

An embodiment of the invention discloses a debug method for a multi-core processor including defining a debug data transmitting zone in a storage device. A first processor core is used for generating debug data and the debug data is transmitted to a second processor core via the debug data transmitting zone for debugging.

An embodiment of the invention further discloses a computer system, including a storage device that has a debug data transmitting zone for storing data. A first processor core, for executing a first application program, is configured to generate debug data and utilize the debug data transmitting zone for storing the debug data when the debug data is generated. A second processor core is configured to execute a second application program and access the data from the debug data transmitting zone.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a computer system according to an embodiment of the invention.

FIG. 2 is another schematic diagram of the computer system shown in FIG. 1.

FIG. 3 is a schematic diagram of a process according to an embodiment of the invention.

### DETAILED DESCRIPTION

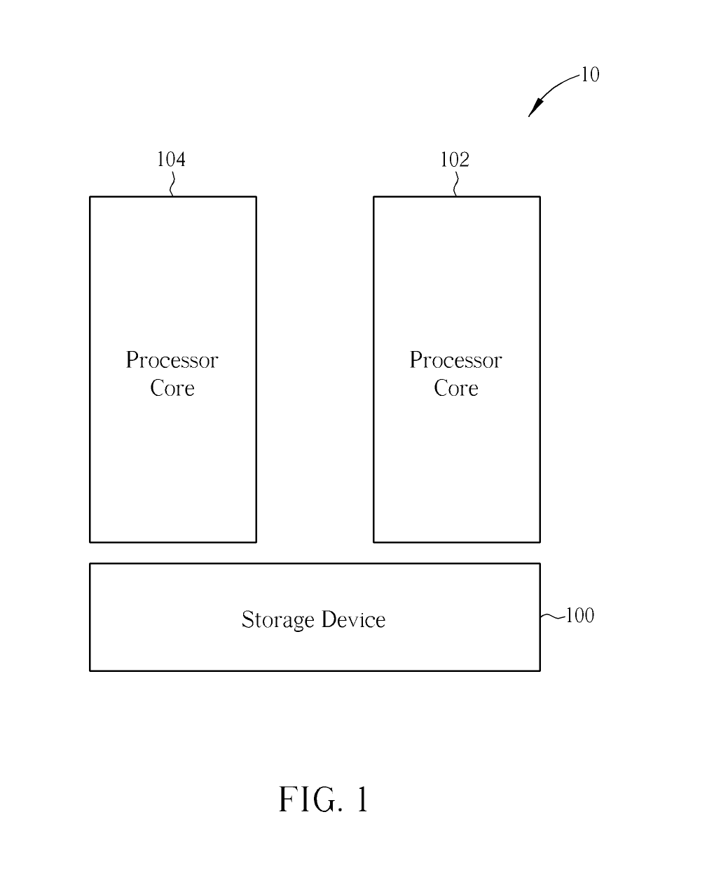

Please refer to FIG. 1, which is a schematic diagram of a computer system 10 according to an embodiment of the invention. The computer system 10 applies to a multi-core processor, for example, the multi-core processor is a central processor, a Digital Signal Processor (DSP) or a System on Chip (SoC), and is not limited thereto. The computer system 10 executes a multi-core program and outputs debug data generated while the multi-core program being executed, so as to allow a user to utilize the debug date for debugging the multi-core program.

As shown in FIG. 1, the computer system 10 comprises a storage device 100, a processor core 102 and a processor core 104. The storage device 100 is utilized for storing data which can be accessed by the processor core 102 and the processor core 104. The storage device 100 can be a memory device such as a flash memory, a PROM, an EEPROM, etc., but is not limited thereto. The processor core 102 and the processor core 104 are utilized for executing operating systems (such as Windows operating system, Linux operating system, etc.), system application programs (such as global position system application program), or other related application programs, but are not limited thereto. The processor core 102 and the processor core 104 are in a same multi-core processor.

In the present invention, the processor core 102 does not have channel for a debug data DATA, and the processor core 104 can output the data DATA to the user so as to allow the user to debug accordingly. In such a situation, the user cannot timely monitor the operating status of the processor core 102 while the processor core 102 executes the system application programs. Therefore, the processor core 102 transmits debug data DATA to the processor core 104 through the storage device 100, so as to allow the user to acquire the debug data through the processor core 104. As a result, the user can utilize the debug data DATA for effectively debugging without additional hardware.

In detail, when the processor core 102 executes the system application program and generates the debug data DATA, the processor core 102 utilizes a message queue object for transmitting the debug data DATA to the storage device 100. The processor core 104 also utilizes a message queue object for receiving the debug data from the storage device 100. Thus, the user can read and analyze the debug data DATA after the processor core 104 receives the debug data DATA and perform debugging on the multi-core program.

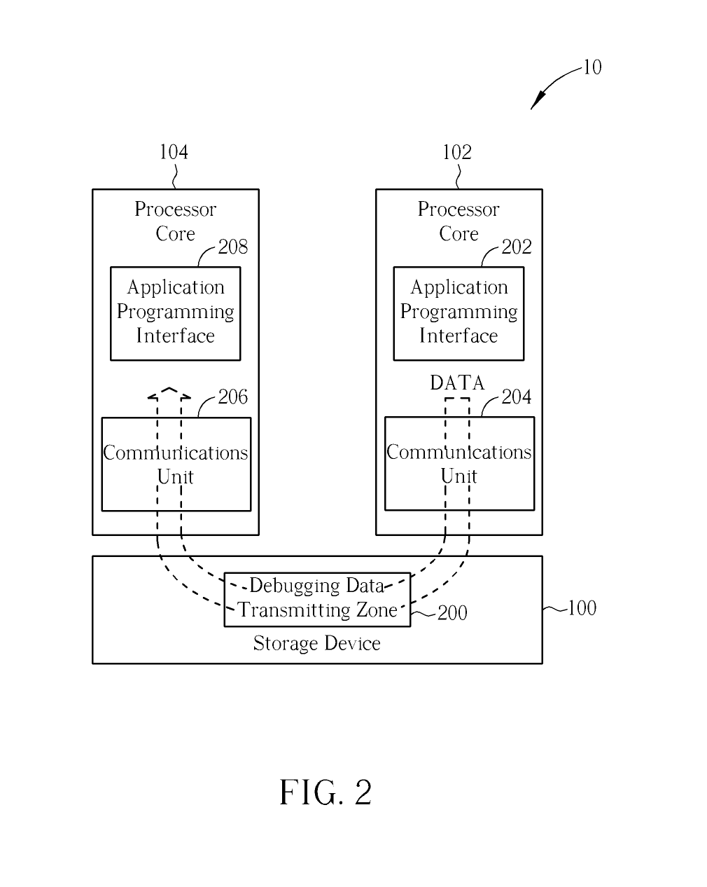

Noticeably, the computer system 10 shown in FIG. 1 is the embodiment of the present invention, and the computer system 10 utilizes function blocks for explaining a concept of the present invention. The implementation methods of all the functional blocks can be appropriately adjusted according to various system demands. For example, please refer to FIG. 2, where FIG. 2 is a schematic diagram of the computer system 10 according to another embodiment of the present invention.

As shown in FIG. 2, the storage 100 comprises a debug data transmitting zone 200 for storing the debug data DATA. The processor 102 comprises an application programming interface 202 and a communications unit 204. The application programming interface 202 is utilized for outputting the debug data DATA generated by the processor core 102 to the communications unit 204. The communications unit 204 is utilized for storing the debug data DATA in the debug date transmitting zone 200. The processor core 104 comprises a communications unit 206 and an application programming interface 208. The communications unit 206 is utilized for accessing the debug data DATA stored in the debug data transmitting zone 200 and outputting the accessed debug data DATA to the application programming interface 208. After the application programming interface 208 receives the debug data DATA, the user utilizes the debug data DATA for debugging the multi-core program.

For example, when the processor core 102 generating the debug data DATA, the application programming interface 202 utilizes a message queue for transmitting the debug data DATA to the communications unit 204. Then, the communications unit 204 stores the debug data DATA in the debug data transmitting zone 200. After the communications unit 204 stores the debug data DATA in the debug data transmitting zone, the communications unit 206 of the processor core 104 accesses the debug data DATA in the debug data transmitting zone 200, and the application programming interface 208 utilizes a message queue object for receiving the debug data DATA from the communications unit 206, so as to allow the user access to the debug data DATA for debugging the multi-core program.

Noticeably, the debug data transmitting zone is achieved by defining an appropriate block of the storage device which is jointly used by each processor core. Thus, those skilled in the art can accordingly observe various modifications according to different applications. For example, the computer system 10 can further comprise a display device (Not shown in FIG. 2) for displaying the debug data DATA in symbols or words on the display device after the processor core 104 receives the debug data DATA, so as to allow the user to read the debug data. In addition, the computer system 10 can further comprise a second storage device (not shown in FIG. 2) for storing the debug data DATA after the processor core 104 receives the debug data DATA, so as to allow the user to observe multiple debug data.

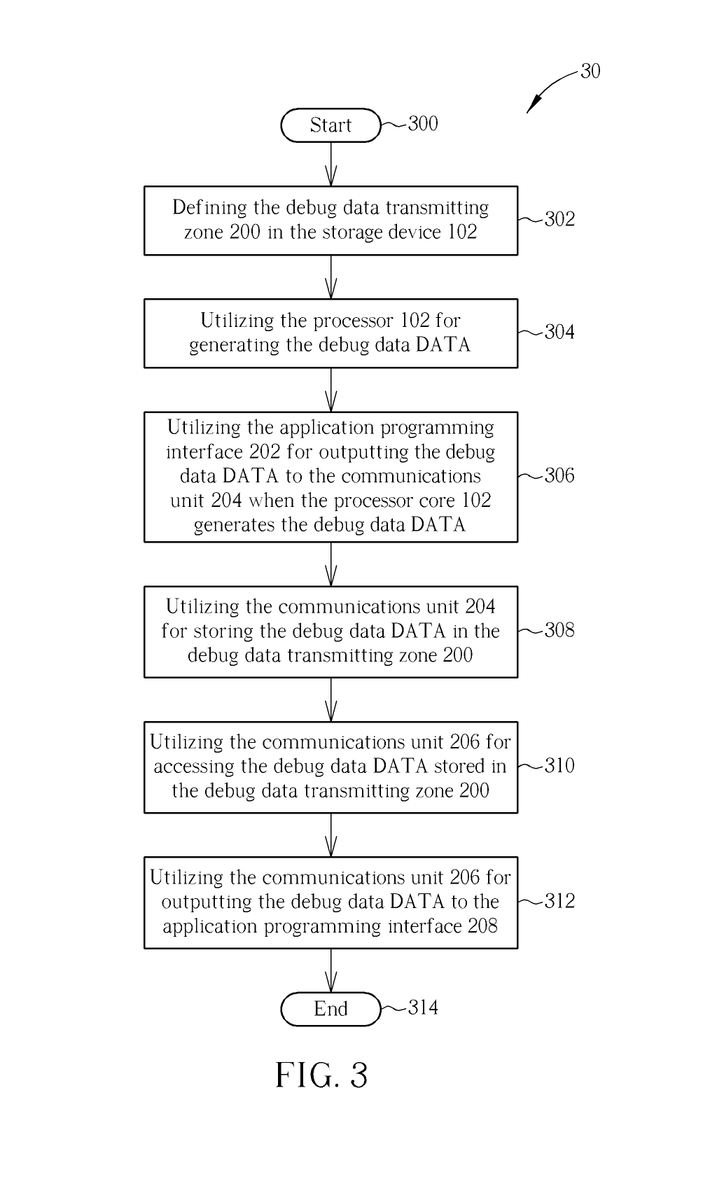

The above mention method of transmitting the debug data DATA from the processor core 102 to the processor core 104 can be further summarized into a debug process 30. Noticeably, the debug process 30 is not limited to the sequence shown in FIG. 3 if a same result can be obtained. Referring to FIG. 3, the debug process 30 comprises:

Step 300: Start.

Step 302: Defining the debug data transmitting zone 200 in the storage device 102.

Step 304: Utilizing the processor 102 for generating the debug data DATA.

Step 306: Utilizing the application programming interface 202 for outputting the debug data DATA to the communications unit 204 when the processor core 102 generates the debug data DATA.

Step 308: Utilizing the communications unit 204 for storing the debug data DATA in the debug data transmitting zone 200.

Step 310: Utilizing the communications unit 206 for accessing the debug data DATA stored in the debug data transmitting zone 200.

Step 312: Utilizing the communications unit 206 for outputting the debug data DATA to the application programming interface 208.

Step 314: End.

For example, please jointly refer to FIG. 2 and FIG. 3. When the computer system 10 is executing a global position system navigation application program, the processor core 102 responds to position signals received from global position system satellites and the processor core 104 responds by calculating navigation information according to the position signals received by the processor core 102. When the user wants to observe the operating status of the processor core 102, the computer system 10 defines the debug data transmitting zone 200 in the storage device 100, so as to allow the processor core 102 and the processor core 104 to transmit the debug data DATA. The debug data DATA is generated while the processor core 102 receives the global position system satellite signals. The application programming interface 202 utilizes a message queue object for outputting the debug data DATA to the communications unit 204. Then the communications unit 204 stores the debug data DATA in the debug data transmitting zone 200. After the debug data DATA is stored in the debug data transmitting zone 200, the communications unit 206 accesses the debug data DATA from the debug data transmitting zone 200. In the computer system 10, the communications unit 206 periodically inquiries whether the debug data transmitting zone stores debug data DATA stored by the communications unit 204. When the communications unit 206 determines that the debug data transmitting zone has debug data DATA stored by the communications unit 204, the communications unit 206 accesses the stored debug data DATA. Finally, the application programming interface 208 utilizes a message queue object for receiving the debug data DATA from the communications unit 206.

Furthermore, the methods of outputting the debug data DATA to the user can be modified according to different applications. For example, the debug process 30 can further comprise utilize the application programming interface 208 for outputting the debug data DATA to a display device after the communications unit 206 outputs the debug data DATA to the application programming interface 208, so as to display the debug data DATA in symbols or words on the display device and allow the user to read the debug data more conveniently. In addition, the debug method 30 can further comprise storing the debug data DATA in a second storage device after the communications unit 206 outputs the debug data to the application programming interface 208. As a result, the user can record and observe the change of the debug data DATA, and can debug more effectively.

To sum up, the present invention utilizes a jointly used storage device for implementing a channel for transmitting debug data, so as to allow the debug data to be transmitted between each processor core. As a result, the user can timely monitor operational statuses of each processor core, and can easily observe errors . In comparison with the prior art, the present invention utilizes an existing storage device for accessing related debug information without additional hardware circuitry.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A debug method for a multi-core processor, comprising:
defining a debug data transmitting zone in a storage device;
utilizing a first processor core for generating debug data; and
transmitting the debug data to a second processor core via the debug data transmitting zone for debugging.

2. The debug method of claim 1, wherein the step of transmitting the debug data to a second processor core via the debug data transmitting zone for debugging comprises:
storing the debug data in the debug data transmitting zone after the first processor core generates the debug data; and
utilizing the second processor core for accessing the debug data from the debug data transmitting zone for debugging.

3. The debug method of claim 2, wherein the step of storing the debug data in the debug data transmitting zone after the first processor core generates the debug data comprises:
utilizing a first application programming interface of the first processor core for transmitting the debug data to a first communication unit of the first processor core after the first processor core generates the debug data; and
utilizing the first communication unit for transmitting the debug data to the debug data transmitting zone.

4. The debug method of claim 2, wherein the step of utilizing the second processor core for accessing the debug data from the debug data transmitting zone for debugging comprises:
utilizing a second communication unit of the second processor core for accessing the debug data from the debug data transmitting zone; and
utilizing the second communication unit for transmitting the accessed debug data to a second application programming interface of the second processor core.

5. The debug method of claim 4, wherein the step of utilizing a second communication unit of the second processor core for accessing the debug data from the debug data transmitting zone comprises:
utilizing the second communication unit for periodically inquiring whether the debug data transmitting zone stores the debug data stored by the first communication unit; and
accessing the debug data when the debug data transmitting zone stores the debug data stored by the first communication unit.

6. The debug method of claim 1, wherein the first processor core and the second processor core are in a same multi-core processor.

7. The debug method of claim 6, wherein the multi-core processor is a central processor unit.

8. The debug method of claim 1, further comprising:
utilizing the second processor core for outputting the debug data to a display device, for displaying the debug data.

9. The debug method of claim 1, further comprising:
utilizing the second processor core for storing the debug data in a second storage device.

10. A computer system, comprising:
a storage device, comprising a debug data transmitting zone for storing data;
a first processor core, for executing a first application program, generating debug data and utilizing the debug data transmitting zone for storing the debug data when generating the debug data; and
a second processor core, for executing a second application program and accessing the data from the debug data transmitting zone.

11. The computer system of claim 10, wherein the first processor core comprises:
a first application programming interface, for outputting the debug data when the first processor core generates the debug data; and
a first communication unit, for storing the debug data in the debug data transmitting zone when receiving the debug data transmitted by the first application programming interface.

12. The computer system of claim 10, wherein the second processor core comprises:
a second application programming interface, for outputting the debug data when receiving the debug data; and
a second communication unit, for accessing the debug data from the debug data transmitting zone and transmitting the debug data to the second application programming interface.

13. The computer system of claim 10, wherein the first processor core and the second processor core are in a same multi-core processor.

14. The computer system of claim 13, wherein the multi-core processor is a central processor unit of an electronic device.

15. The computer system of claim 10, further comprising a display device, for displaying the debug data after the second processor core receives the debug data through the debug data transmitting zone.

16. The computer system of claim 10, further comprising a second storage device, for storing the debug data after the second processor core receives the debug data through the debug data transmitting zone.
